(19) United States
(12) Patent Application Publication
(10) Pub. No.: US 2025/0100126 A1
(43) Pub. Date: Mar. 27, 2025

(54) TOOLBOX IINING AND MANUFACTURING PROCESS THEREOF

(71) Applicant: Bell Huang, Taichung City (TW)

(72) Inventor: Bell Huang, Taichung City (TW)

(21) Appl. No.: 18/370,880

(22) Filed: Sep. 21, 2023

(51) Int. Cl. B25H 3/02; B21D 28/26; B25H 3/00; B65D 25/10

(52) U.S. Cl. CPC B25H 3/02; B21D 28/26; B65D 25/10; B25H 3/003

(57) ABSTRACT

The present invention relates to a toolbox lining. The toolbox lining is made of a metal material and has a mounting hole. The mounting hole has an inner edge connected to a plurality of retaining tabs, which are bent in the same direction at an angle not exceeding 90 degrees. The use of the retaining tabs with bending angles less than 90 degrees to fix replacement components for an operation head end of a hand tool in the mounting hole ensures the functionality of securely storing the replacement components in a toolbox without the need for plastic foam materials.

### BACKGROUND OF THE INVENTION

### Fields of the Invention

The present invention relates to a toolbox lining and manufacturing process thereof. The toolbox lining is disposed in the interior of the toolbox to provide secure storage for various tool accessories, such as different sizes of screwdriver heads, sockets, etc.

### Descriptions of Related Art

Hand tools are essential products used for disassembling and assembling components. With technological advancements and requirements, there is a need for optimal configurations of components for diverse application environments. Consequently, various corresponding hand tools are required to accommodate a variety of component configurations. However, as the types of the hand tool increase, users are burdened with the need to carry a larger variety of tools. For instance, maintenance personnel must carry numerous different screwdrivers. To address this issue, hand tools with an interchangeable operation head end have developed.

Although the hand tools with the interchangeable operation head end significantly reduce the overall weight of tools needed to be carried, the replacement components for the operation head end are generally small in size and come in large quantities. To ensure easy access to suitable sizes when needed, it is common to store these replacement components in a toolbox. To prevent these replacement components from moving around within the toolbox, a popular approach is to use plastic foam materials such as EVA as the lining. The plastic foam material possesses a certain level of elasticity, allowing secure storage of the replacement components by creating holes slightly smaller than the size of the replacement components for the operation head end.

However, in recent years, with the rise of environmental awareness, the European Union has been progressively promoting the use of green materials, and there are increasing restrictions on the mainstream material for plastic foam, EVA. Consequently, using plastic foam materials as lining materials for toolboxes is gradually being phased out. Therefore, there is a need to develop a new type of toolbox lining.

### SUMMARY OF THE INVENTION

The present invention utilizes a metal material for the toolbox lining to address the environmental issues associated with plastic foam materials. Additionally, a plurality of retaining tabs with bending angles less than 90 degrees is employed to secure the replacement components for the operation head end of the hand tool in the mounting holes. This ensures that the replacement components can be securely stored in the toolbox without the use of plastic foam materials. Furthermore, the manufacturing process of the toolbox lining is provided to demonstrate the feasibility for its production.

To achieve the above objectives and advantages, the present invention provides a toolbox lining made of a metal material. The toolbox lining is formed with a mounting hole having an inner edge connected to a plurality of retaining tabs. The plurality of retaining tabs is bent in the same direction at a bending angle not exceeding 90 degrees.

The present invention also provides a manufacturing process of the toolbox lining, comprising the following steps: a preparation step of preparing a metal sheet; a cutting step of designating a target area on the metal sheet, and cutting a plurality of edge cut marks that penetrates the metal sheet in the target area using a processing machine, as well as cutting a separation cut mark between uncut portions of the target area using the processing machine; a stamping step of preparing a processing machine with a stamping head that matches a shape of the target area and pressing the stamping head of the processing machine onto the target area to cause the metal sheet in the target area to bend in a stamping direction with the separation cut mark as a boundary, thus forming a plurality of retaining tabs with a bending angle less than 90 degrees and forming a mounting hole in the target area.

### BRIEF DESCRIPTION OF THE DRAWINGS

FIG. 1 is a perspective schematic view for illustration of the present invention.

FIG. 2 is a perspective schematic view from another angle for illustration of the present invention.

FIG. 3 is a cross-sectional schematic view taken along the line III-III of FIG. 1.

FIG. 4 is a schematic view for illustration of actual storage of various replacement components according to the present invention.

FIG. 5 is a cross-sectional schematic view taken along the line V-V of FIG. 4.

FIG. 6 is an exploded schematic view of a toolbox lining and accessories of the present invention.

FIG. 7 is a cross-sectional schematic view taken along the line VII-VII of FIG. 4.

FIG. 8 is a flowchart of the present invention.

FIG. 9 is a schematic view of a metal sheet.

FIG. 10 is a schematic view of a target area.

FIG. 11 is a schematic view of edge cut marks and separation cut marks.

FIG. 12 is a schematic view of formation of retaining tabs by stamping.

FIG. 13 is a schematic view of a metal sheet after removal of corners.

FIG. 14 is a schematic view of formation of flanges by folding.

### DETAILED DESCRIPTION OF THE PREFERRED EMBODIMENT

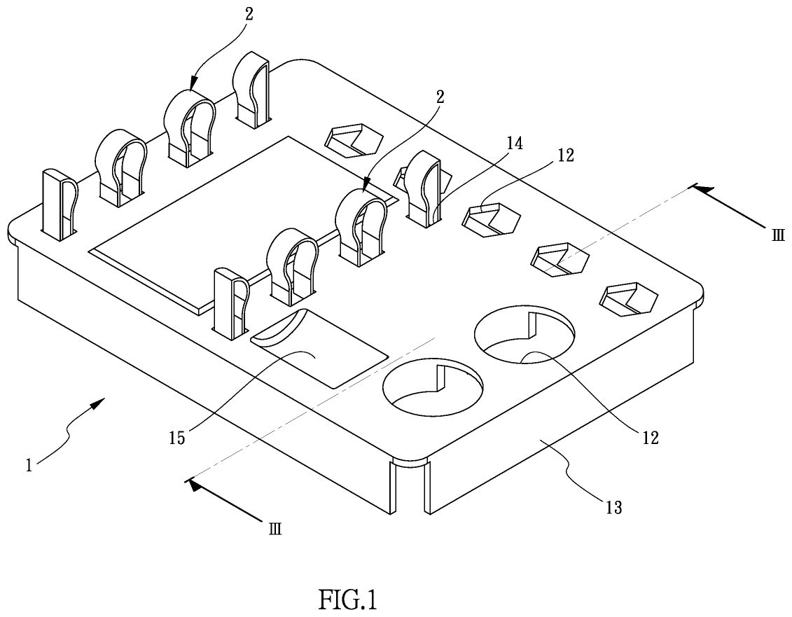

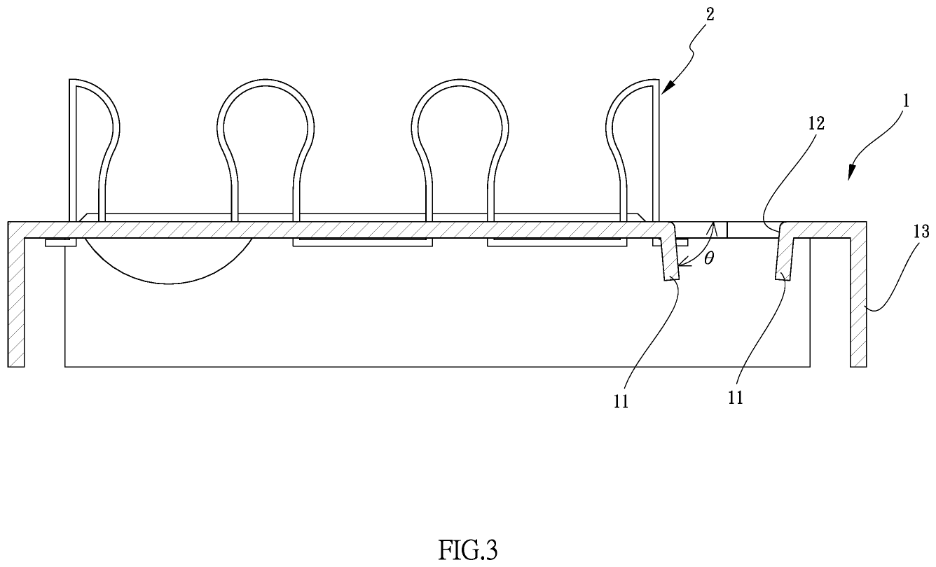

In order to provide a more detailed understanding of the embodiments of the present invention, please refer to the accompanying diagrams, as shown in FIGS. 1 to 3. The present invention provides a toolbox lining 1 made of a metal material. The toolbox lining 1 has mounting holes 12 each with an inner edge connected to a plurality of retaining tabs 11. The plurality of retaining tabs 11 is bent in the same direction at a bending angle θ not exceeding 90 degrees.

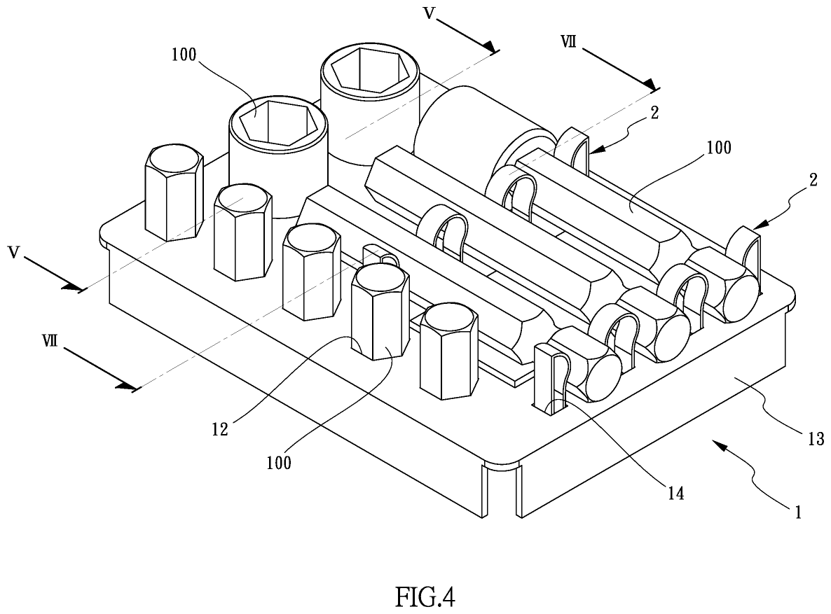

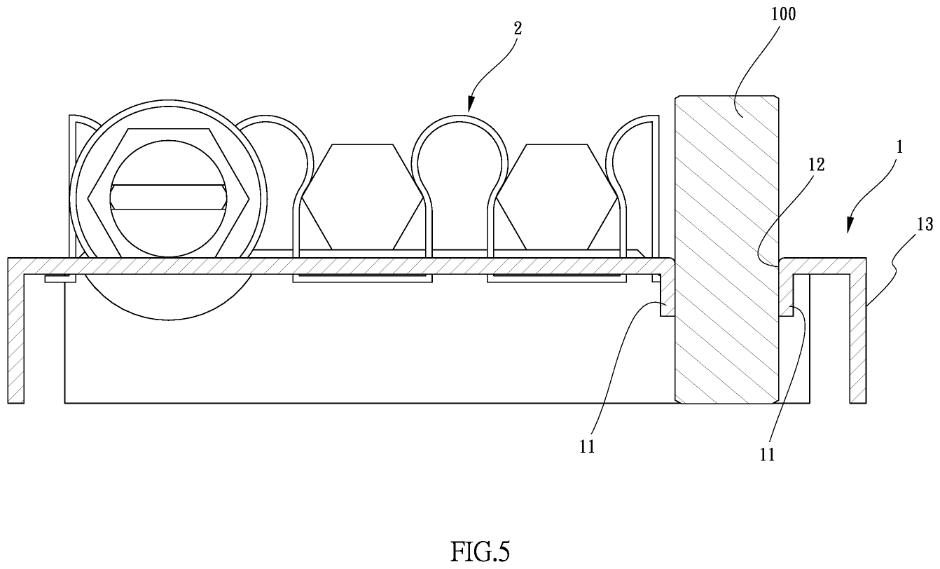

Continuing from the above description, the embodiments of the present invention are further described in details. The toolbox lining 1 of the present invention utilizes a metal material (such as iron, galvanized iron, etc.) to address the environmental issues associated with plastic foam materials. Metal materials are more durable and less prone to damage compared to plastic foam materials. Additionally, metals are easier to recycle and have a far longer lifecycle compared to plastic foam materials, making them more environmentally friendly. The structure of the present invention used to secure the replacement components 100 primarily relies on the plurality of retaining tabs 11. It is necessary for these retaining tabs 11 to have a bending angle θ less than 90 degrees. If the angle exceeds 90 degrees, it becomes difficult to exert gripping force on the replacement components 100 placed in the mounting hole 12. The specific implementation of using the plurality of retaining tabs 11 to secure the replacement components 100 can be seen in FIGS. 4 and 5. The angles θ for easy production purposes are within the range of 80 to 90 degrees. Among them, angles such as 85, 86, 87, 88, and 89 degrees provide sufficient gripping force without making it difficult to remove the replacement components 100, ensuring the secure storage of the replacement components 100 in the toolbox without the use of plastic foam materials.

Based on the above, it can be concluded that the present invention indeed provides a new type of toolbox lining 1, which exhibits novelty and inventive step.

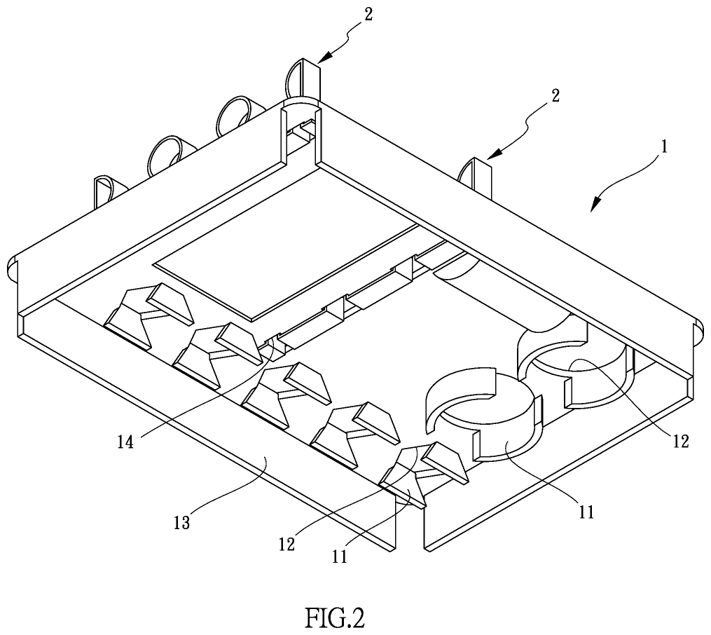

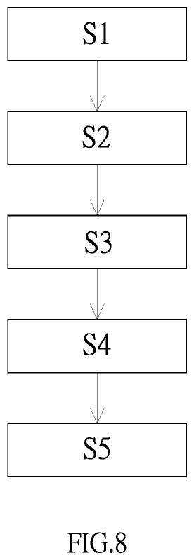

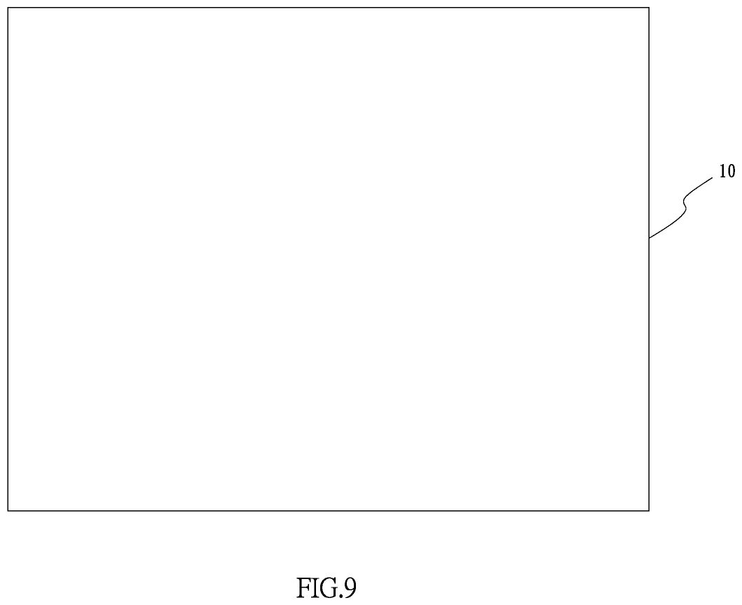

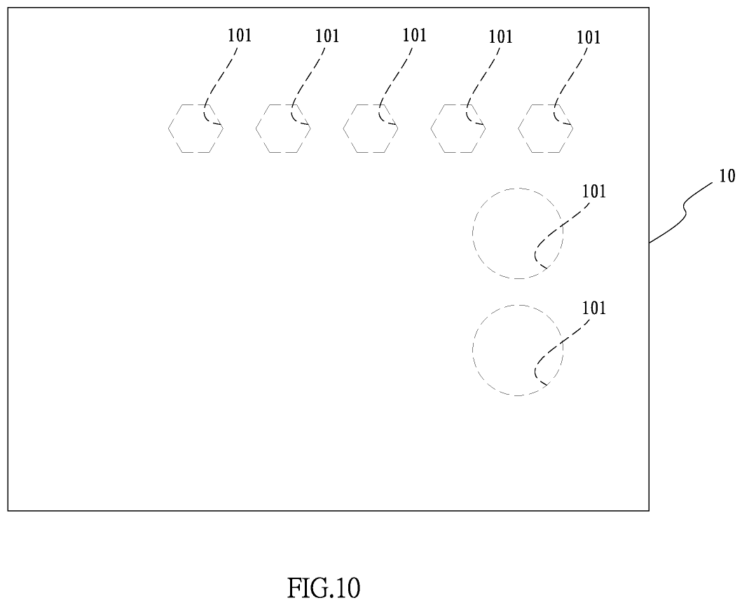

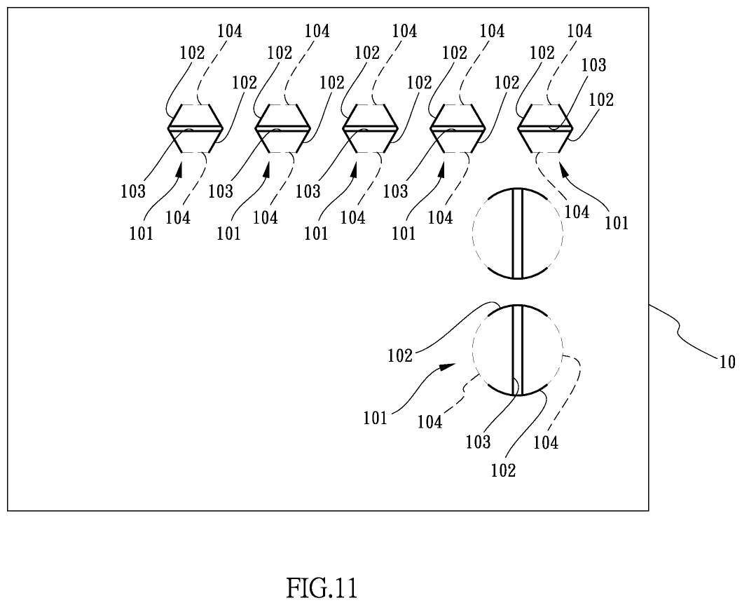

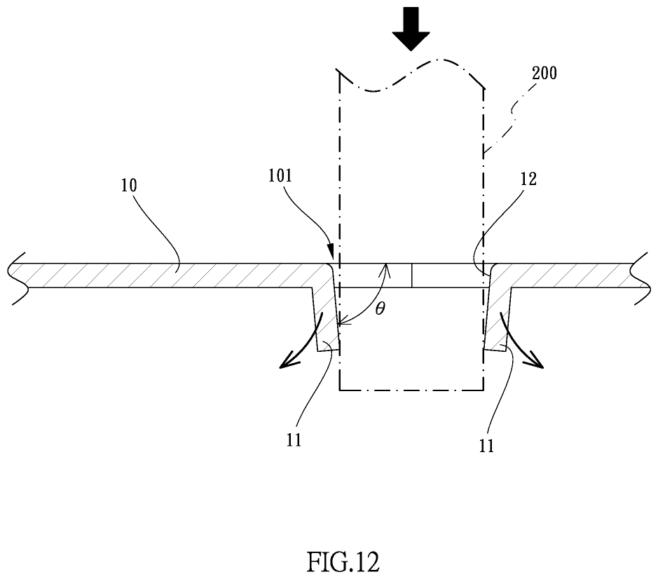

Furthermore, a manufacturing process of the toolbox lining is provided, as shown in FIG. 8. The manufacturing process includes the following steps: a preparation step (S1) for preparing a metal sheet 10, as shown in FIG. 9; a cutting step (S2) for designating a target area 101 (illustrated by dashed lines in FIG. 10, and exemplified by a plurality of target areas 101 with circular or hexangular shapes by way of example in this embodiment), as shown in FIG. 10, and using a processing machine to cut a plurality of edge cut marks 102 that penetrate the metal sheet 10 and to cut separation cut marks 103 between the uncut portions of the target area using the processing machine, as shown in FIG. 11 for illustration of the various types of marks described above, wherein the edge cut marks 102 are in an arc-curved shape for the target area 101 with a circular shape, whereas for the target area 101 with a hexagonal shape, the edge cut marks 102 have an angular shape; a stamping step (S3) for preparing a processing machine with a stamping head 200 that matches the shape of the target areas 101 and pressing the stamping head 200 of the processing machine onto the target areas 10, as shown in FIG. 12. Accordingly, the target areas 101 of the metal sheet 10 are bent in the stamping direction with the separation cut marks 103 as boundaries, thus forming a plurality of retaining tabs 11. The bending angle θ of the retaining tabs 11 is less than 90 degrees, and each of the target areas 101 forms a mounting hole 12. Depending on the shape of the target areas 101 and the stamping head 200, the mounting holes 12 can have a circular or hexagonal shape, as shown in FIG. 1, and each of the retaining tabs 11 can exhibit an arc-curved sheet shape or flat trapezoid shape, as shown in FIG. 2.

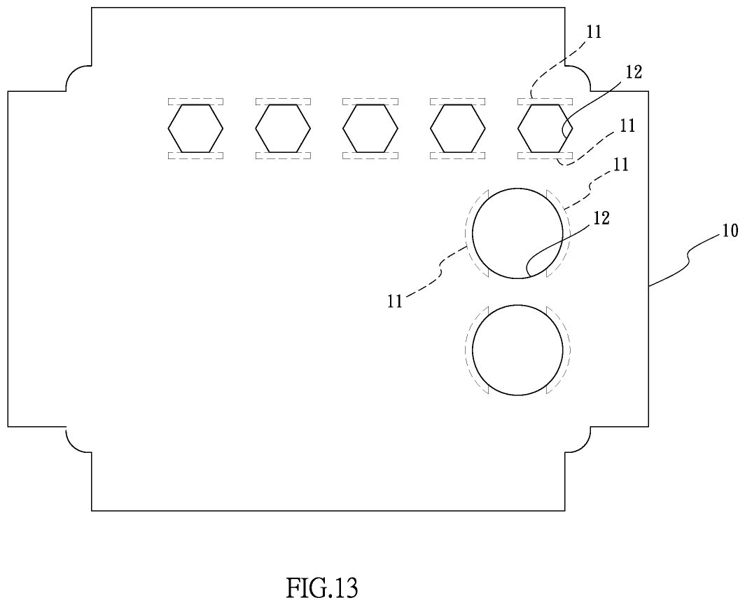

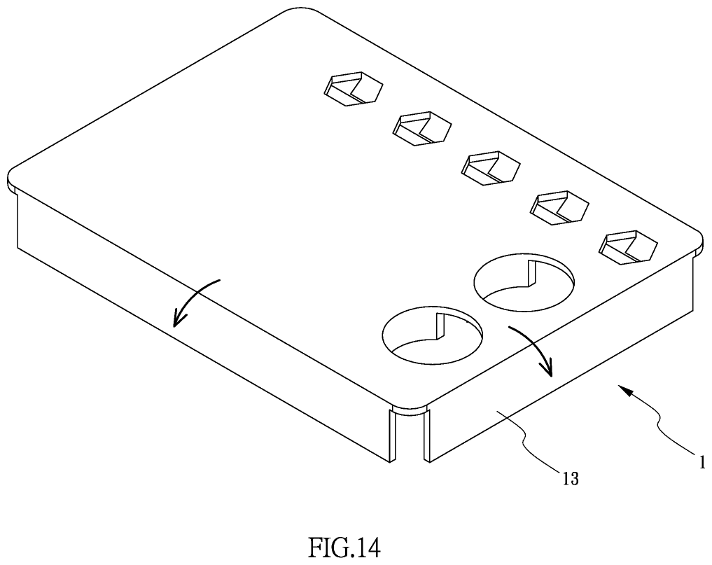

Furthermore, as shown in FIG. 8, the manufacturing process can further include a corner cutting step (S4) after the preparation step (S1). In this embodiment, the corner cutting step (S4) is performed subsequent to the stamping step (S3), by way of example. Using the processing machine, the corners of the metal sheet 10 are removed to create a cross-like pattern (as illustrated in FIG. 13). The corner cutting step (S4) is then followed by a folding step (S5), as shown in FIG. 14, in which the protruding edges of the metal sheet 10 are folded in the direction of bending the plurality of retaining tabs 11, resulting in the formation of a plurality of flanges 13, which enhances the secure installation of the toolbox lining 1 inside the toolbox. In practical applications, the corner cutting step (S4) and the folding step (S5) can be combined into a single step.

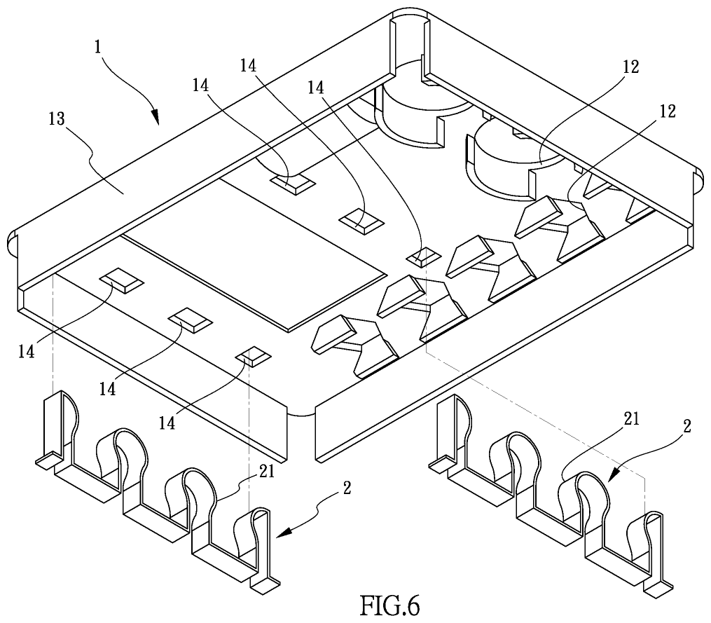

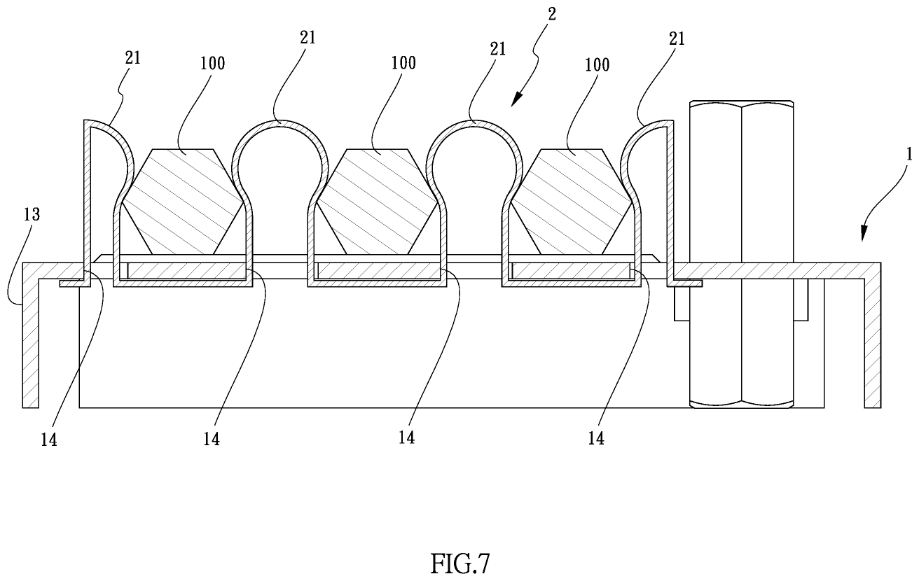

Moreover, the manufacturing process may further include an opening step after the preparation step (S1). That is, the opening step can be performed subsequent to anyone of the steps starting from the preparation step (S1) up to the corner cutting step (S5). During this step, the metal sheet 10 is processed to include a plurality of accessory installation holes 14 using the processing machine. Once the formation of the accessory installation holes 14 is completed, accessories 2 can be installed, as shown in FIGS. 1, 6 and 7. In this embodiment, the accessories have a wavy shape and include a plurality of protruding wave portions 21. The accessories 2 are installed by inserting the protruding wave portions 21 through the plurality of accessory installation holes 14. After installing the accessories 2, the toolbox lining 1 can accommodate a greater variety of replacement components 100, as shown in FIG. 4.

Additionally, the toolbox lining 1 can be processed to include grooves 15 for auxiliary positioning, as illustrated in FIGS. 1 and 4, according to requirements.

What is claimed is:

1. A toolbox lining, wherein: the toolbox lining is made of a metal material and has a mounting hole with an inner edge connected to a plurality of retaining tabs, and the plurality of retaining tabs is bent in the same direction at a bending angle not exceeding 90 degrees.

2. The toolbox lining as claimed in claim 1, wherein the mounting hole has a circular shape, and the plurality of retaining tabs has an arc-curved sheet shape.

3. The toolbox lining as claimed in claim 1, wherein the mounting hole has a hexangular shape, and the plurality of retaining tabs has a flat trapezoid shape.

4. The toolbox lining as claimed in claim 1, wherein the toolbox lining has a plurality of flanges at a peripheral edge thereof, the plurality of flanges is bent in a consistent direction, and bending directions of both the plurality of flanges and the plurality of retaining tabs are the same.

5. The toolbox lining as claimed in claim 1, wherein the toolbox lining has a plurality of accessory installation holes and further comprises an accessory having a wavy shape and including a plurality of protruding wave portions and installed by inserting the plurality of protruding wave portions through the plurality of accessory installation holes.

6. A manufacturing process of a toolbox lining, which comprises the following steps of:
a preparation step of preparing a metal sheet;
a cutting step of designating a target area on the metal sheet, and cutting a plurality of edge cut marks that penetrates the metal sheet in the target area using a processing machine, as well as cutting a separation cut mark between uncut portions of the target area using the processing machine; and
a stamping step of preparing a processing machine with a stamping head that matches a shape of the target area and pressing the stamping head of the processing machine onto the target area to cause the metal sheet in the target area to bend in a stamping direction with the separation cut mark as a boundary, thus forming a plurality of retaining tabs with a bending angle less than 90 degrees and forming a mounting hole in the target area.

7. The manufacturing process of the toolbox lining as claimed in claim 6, wherein the target area has a circular shape, and the plurality of the edge cut marks has an arc-curved shape.

8. The manufacturing process of the toolbox lining as claimed in claim 6, wherein the target area has a hexangular shape, and the plurality of the edge cut marks has an angular shape.

9. The manufacturing process of the toolbox lining as claimed in claim 6, after anyone of the steps, further comprising a corner cutting step of removing corners of the metal sheet to shape the metal sheet into a cross-like pattern; and after the corner cutting step, a folding step of folding protruding edges of the metal sheet in a direction of bending the plurality of retaining tabs to form a plurality of flanges.

10. The manufacturing process of the toolbox lining as claimed in claim 6, after anyone of the steps, further comprising an opening step of processing the metal sheet to include a plurality of accessory installation holes using the processing machine.
